(19) United States
(12) Patent Application Publication
(10) Pub. No.: US 2009/0114474 A1
(43) Pub. Date: May 7, 2009

(54) Megaphone sign for use at events

(76) Inventor: Scott David Morgan, Mission Viejo, CA (US)

Correspondence Address: ZUBER & TAILLIEU LLP, 10866 WILSHIRE BLVD., SUITE 300, LOS ANGELES, CA, 90024, US

(21) Appl. No.: 11/983,099

(22) Filed: Nov. 6, 2007

(51) Int. Cl. G10K 11/00; G09F 7/02

(52) U.S. Cl. 181/178; 40/616

(57) ABSTRACT

A portable sign which can be used at sporting or other events that doubles as a megaphone formed from a flexible sheet of dry erase material cut into the shape of a “baseball field”—having two opposing, elongated sides, an upper arced edge and a complimentary lower arced edge. The flexible dry erase material has an inner dry erase surface which is ideal for use in making signs for holding up while attending a sporting or other event. The device further includes an attachment mechanism, such as Velcro, which is preferably affixed to and positioned on the opposite, elongated “V” shaped sides of the material such that the material can be rolled/folded into a conical shape with the opposite elongated sides then being held together via the attachment mechanism, i.e. the Velcro, thereby forming a megaphone which can be used to shout and cheer at the event.

### FIELD OF THE INVENTION

The invention is directed toward signs which are used by viewers at indoor or outdoor events such as sporting events or contests. More specifically, the invention is directed toward a flat flexible sign which may also be used as a megaphone.

### BACKGROUND OF THE INVENTION

Often viewers of an event (such as a sporting event or contest) at an indoor or outdoor stadium will bring a hand made sign or board with them, which they may then hold up at appropriate moments when in the stadium or venue, for display to all during the course of the event. These signs may be hand made or professionally made on cardboard, a poster board, or other suitable surface. Additionally, they may come in various shapes, sizes and colors.

One limitation in using this type of signage is that it must be prepared in advance and does not allow a user to change the sign as the event progresses. For example, a user might wish to design a sign in order to cheer on his or her favorite player at the game but unless he or she creates several signs, he or she cannot do so for several different players. Accordingly, for individuals whom have several favorite players on any one team, that individual must make a separate sign for each individual or one sign designed to encourage multiple individuals on the team.

Since the number of signs any one individual is likely to prepare and bring to the sporting event is limited, an individual audience participant may find other ways to encourage his or her team to win the contest or event. One such way is to cheer loudly during the course of the game or event. Often a user will shout loudly out to the players, the referees, and/or the coaching staff in order to get their attention, express support and/or shout out disapproval over a bad or unfair referee call or penalty. If a user/audience member must cheer loudly over the course of an entire game and participate in shouting and yelling at various intervals, the stress and/or strain on that individual person's vocal cords can be detrimental.

One way for a user to save his or her voice and reduce stress or strain on his or her voice is to bring a megaphone or similar device to the event. There are number of different megaphone designs and options known in the art, most of which have a bugle type design which includes a preformed conical shape with an outward opening at one end. Such a design is well known in the art and is used to magnify or broadcast a user's voice when he/she yells into the other end of the megaphone. For example, U.S. Pat. No. 5,160,815 reveals a conically shaped megaphone which has a plurality of openings at one end, while U.S. Pat. No. 5,967,875 reveals a megaphone which has an attachable base so that it may also serve as a cup. Finally, U.S. Design Pat. No. 478,711 reveals a hat design which also doubles as megaphone.

While these designs may vary somewhat in size and material composition, they are all generally made in a sturdy conical shape having a smaller opening at a first end, into which the user speaks/yells, and a larger opening at the opposite end, through which the magnified or amplified voice is projected. One drawback to a conventional megaphone is its size and compactness/portability. Such typical designs do not easily lend themselves to easy transportation/portability and therefore a user must often carry a large, cumbersome megaphone formed of plastic or some other material into the event. This is less then ideal and, accordingly, what is needed is a megaphone having a design and structure so that it can be easily carried to and from the event.

### SUMMARY OF THE INVENTION

The invention is directed toward a portable sign which can be used at sporting or other events and which also doubles as a megaphone. More specifically, the invention is directed toward a flexible sheet of dry erase material cut into the shape of a “baseball field”—having two opposing, elongated, and “V” shaped sides, an upper arced or curved edge and a complimentary lower arced or curved edge. The flexible dry erase material has an outer rough surface and an inner dry erase surface which is ideal for use in making signs for holding up while attending a sporting or other event. More specifically, the dry erase material allows a fan to create on-the-spot signs and/or messages and to erase, change or modify these message at any time during the event by simply wiping the dry erase material clean and then creating a new sign or message.

In a preferred embodiment, the device of the present invention further includes an attachment mechanism, such as Velcro, which is preferably affixed to and positioned on the opposite, elongated “V” shaped sides of the fan or “baseball field” shaped material such that the flexible fan shaped material can be rolled/folded into a conical shape with the opposite elongated sides then being held together via the attachment mechanism, i.e. the Velcro, thereby forming a megaphone which can be used to shout and cheer at the event. More specifically, a strip of Velcro “loops” is affixed on a first side of the invention along one of the elongated “V” shaped sides, while a strip of Velcro “hooks” is affixed on the opposite side of the invention along the opposite elongated “V” shaped side. The two sides are then folded/rolled over and fastened together—such that the Velcro “loops” and “hooks” are engaged—thereby forming a conical shape having a first small open end, and a larger opposite open end at the other end of the conical shape.

### DESCRIPTION OF THE FIGURES

FIG. 1 illustrates a perspective view of the flexible sign and megaphone of the present invention;

FIG. 2 illustrates an outer side view of the flexible sign and megaphone of the present invention;

FIG. 3 illustrates an inner side view of the flexible sign and megaphone of the present invention;

FIG. 4 illustrates an alternate embodiment for an outer side view of the flexible sign and megaphone of the present invention where the outer side has been adorned with decorative items;

FIG. 5 illustrates a perspective view of the flexible sign and megaphone of the present invention when the device has been rolled/folded into a megaphone shape; and

FIG. 6 illustrates a side view of the flexible sign and megaphone of the present invention when the device has been rolled/folded into a megaphone shape.

### DETAILED DESCRIPTION OF PREFERRED EMBODIMENTS

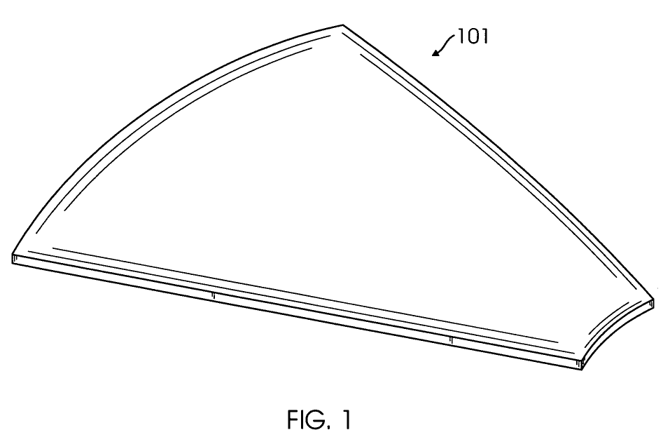

The invention is directed toward a portable sign which can be used at sporting or other events and which also doubles as a megaphone. FIG. 1 illustrates a perspective view of the flexible sign and megaphone of the present invention. As shown in FIG. 1, the invention is formed from an underlying layer 101 of a flexible sheet of dry erase material cut into the shape of a “baseball field” or fan. Accordingly, the design has two opposing, elongated, and “V” shaped sides 102 and 103, an upper arced or curved edge 104 and a complimentary lower arced or curved edge 105.

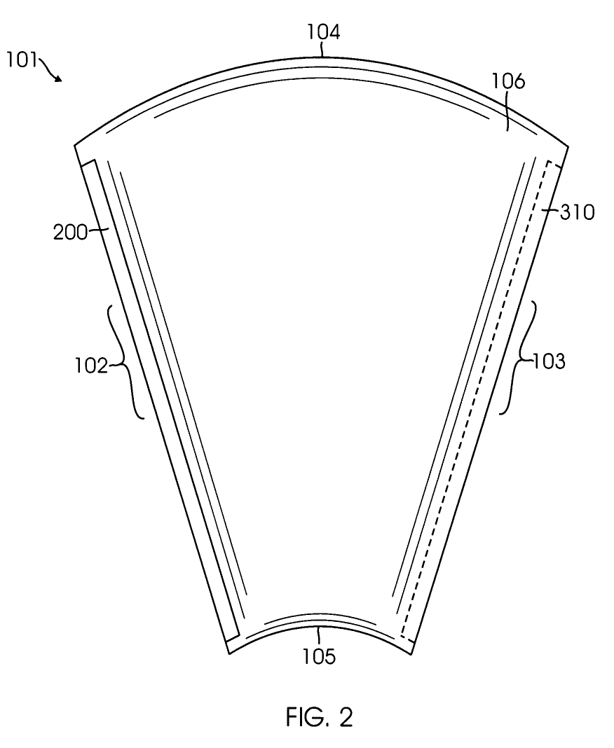

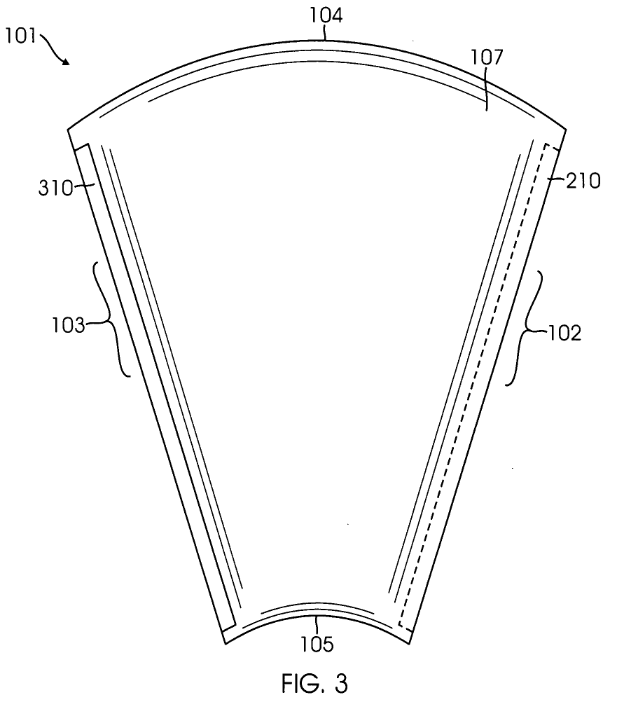

The flexible dry erase material 101 has a rough surface which will form the outer surface 106 of the device and a smooth, glossy dry erase surface which forms an inside surface 107 of the flexible sign and megaphone. FIG. 2 and FIG. 3 illustrate the outer and inner surfaces 106, 107 of the flexible sign and megaphone of the present invention, respectively. Accordingly, FIG. 2 shows the outer surface 106 of the invention, while FIG. 3 illustrates the smooth, glossy dry erase surface the dry erase material which forms the inside surface of the invention. The smooth, glossy dry erase surface of the dry erase material is ideal for use in making signs for holding up while attending a sporting or other event. More specifically, the dry erase material allows a fan to create on-the-spot signs and/or messages and to erase, change or modify these messages at any time during the event by simply wiping the smooth, glossy surface of the dry erase material clean and then creating a new sign or message.

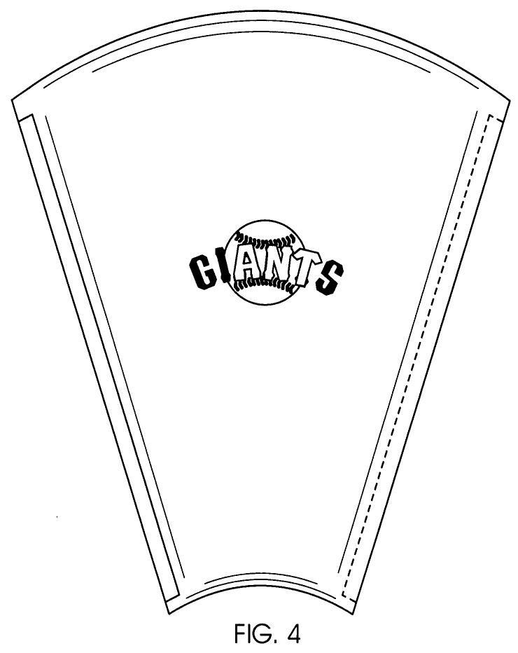

In a preferred embodiment, the outer surface of the flexible material may be covered with an added layer of decorative nylon, nylon polyester, felt, cotton, or other material affixed and sealed to the outer surface. This material may be in any desired color or color-combination and may be adorned with pre-printed logos or graphics which might illustrate a team name or logo. FIG. 4 illustrates an alternate embodiment for an outer side view of the flexible sign and megaphone of the present invention where the outer side has been adorned with decorative items. In the embodiment shown in FIG. 4, the material affixed to the outer surface will preferably be of a black and orange color scheme and includes labels and logos for the SAN FRANCISCO GIANTS™. It is understood that this embodiment is shown for illustrative purposes only in order to describe further aspects of the invention and the invention is not necessarily intended to be limited in any way. Accordingly, the outer surface of the invention may include material of any color scheme—such as gold and green, navy blue and white, or light blue and yellow and may be adorned with logos and/or names from any team in any amateur, college or professional sport such as baseball, football, or hockey. In short, the possibilities are limitless.

In a preferred embodiment, the device of the present invention further includes an attachment mechanism which is used to hold the invention closed when it is rolled/folded into a megaophone. More specifically, an attachment mechanism, such as Velcro, is preferably affixed to and positioned on the opposite, elongated “V” shaped sides of the fan such that the flexible fan shaped material can be rolled/folded into a conical shape with the opposite elongated sides then being held together via the attachment mechanism, i.e. the Velcro, thereby forming a megaphone which can be used to shout and cheer at the event.

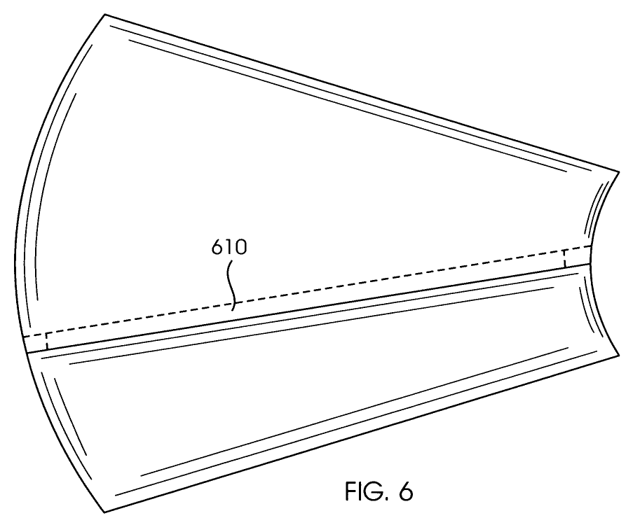

Referring again to FIGS. 2 and 3, a strip of Velcro “loops” 210 is affixed on the outer side of the invention along one of the elongated “V” shaped sides, while a strip of Velcro “hooks” 310 is affixed on the opposite inner side of the invention along the opposite elongated “V” shaped side. The two sides are then folded/rolled over and fastened together—such that the Velcro “loops” and “hooks” are engaged—thereby forming a conical shape. FIG. 6 illustrates a side view of the flexible sign and megaphone of the present invention when the device has been rolled/folded into a megaphone shape. As shown, the two Velcro strips are aligned and overlapped, forming one cohesive strip 610, such that the Velcro “loops” and “hooks” are engaged—thereby forming a conical shape.

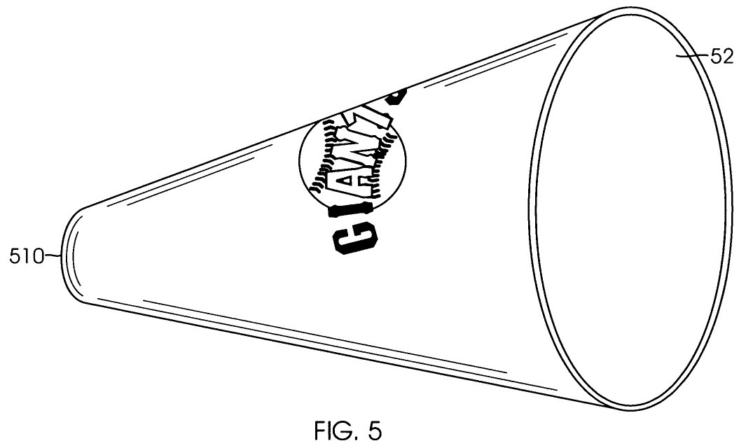

FIG. 5 illustrates a perspective view of the flexible sign and megaphone of the present invention when the device has been rolled/folded into a megaphone shape. As shown, when the flexible material has been rolled/folded over into a conical or megaphone shape, it will have a first small open end 510 on the side formed from the smaller curved or arced shape edge, and a larger opposite open 510 end at the other end of the conical shape, formed from the larger curved or arced shaped edge. In use, a user can then hold the flexible material—now rolled up into a conical shape—up to his or her mouth such that the small opening is positioned adjacent to the user's mouth. When the user shouts or yells into the megaphone his or her voice is amplified and directed outward, through the larger opening.

Although a preferred embodiment of the present invention has been described for illustrative purposes, those skilled in the art will appreciate that various modifications, additions and substitutions are possible, without departing from the spirit and scope of the invention and the invention is not intended to be limited to any one particular embodiment except as claimed.

What is claimed is:

1. A sign for use at sporting events comprising:
a sheet of flexible dry erase material cut into the shape of a fan having two opposing, elongated sides, an upper arced edge and a complimentary lower arced edge; and
a releasable attachment mechanism for holding the two opposing elongated sides together when the sheet of flexible dry erase material is rolled or folded over, thereby forming a conically shaped megaphone.

2. The sign of claim 1, wherein the releasable attachment mechanism includes a first strip of Velcro “loops” coupled along one of the elongated sides and a second strip of Velcro “hooks” coupled along the other elongated side.

3. The sign of claim 1 wherein one surface of the sheet of flexible dry erase material is shiny and capable of being written on and erased a plurality of times such that numerous individual signs can be created and changed using the sheet of flexible dry erase material.

4. The sign of claim 3 wherein an opposite surface of the sheet of flexible dry erase material is covered with a layer of decorative nylon, nylon polyester, felt, cotton, or other cloth material affixed and sealed to the opposite surface.

5. The sign of claim 4, wherein the cloth material may be in any desired color or color-combination and may be adorned with pre-printed logos or graphics which illustrate a professional sports team name or logo.

6. A megaphone for use at sporting events comprising:
a sheet of flexible dry erase material cut into the shape of a fan having a pair of elongated sides which when rolled over form a conical shape thereby defining a small opening at a first end and a second, larger opening at a second and opposite end; and
a releasable attachment mechanism for holding the pair of elongated sides together.

7. The megaphone of claim 6, wherein the releasable attachment mechanism includes a first strip of Velcro “loops” coupled along one of the elongated sides and a second strip of Velcro “hooks” coupled along the other elongated side.

8. The megaphone of claim 6 wherein the releasable attachment mechanism may be released, allowing the pair of elongated sides to be fully separate such that the sheet of flexible dry erase material may used to create a sign.

9. The megaphone of claim 8 wherein one surface of the sheet of flexible dry erase material is shiny and capable of being written on and erased a plurality of times.

10. The megaphone of claim 9 wherein an opposite surface of the sheet of flexible dry erase material is covered with a layer of decorative nylon, nylon polyester, felt, cotton, or other cloth material affixed and sealed to the opposite surface.

11. The megaphone of claim 10, wherein the cloth material may be in any desired color or color-combination and may be adorned with pre-printed logos or graphics which illustrate a professional sports team name or logo.
